(19) United States
(12) Patent Application Publication
(10) Pub. No.: US 2022/0285857 A1
(43) Pub. Date: Sep. 8, 2022

(54) BASE STATION ANTENNAS HAVING LOW COST WIDEBAND CROSS-DIPOLE RADIATING ELEMENTS

(71) Applicant: CommScope Technologies LLC, Hickory, NC (US)

(72) Inventors: Lakshminarayana POLLAYI, Srikakulam (IN); Kumara Swamy KASANI, Godavarikhani (IN); Lenin NARAGANI, Hyderabad (IN)

(21) Appl. No.: 17/629,589

(22) PCT Filed: Jul. 9, 2020
(86) PCT No.: PCT/US2020/041340

§ 371 Date: Jan. 24, 2022

Related U.S. Application Data
(60) Provisional application No. 62/893,975, filed on Aug. 30, 2019.

(51) Int. Cl. H01Q 21/26; H01Q 1/24; H01Q 19/10; H01Q 5/48; H01Q 9/28

(52) U.S. Cl. CPC H01Q 21/26; H01Q 1/246; H01Q 19/108; H01Q 5/48; H01Q 9/285

(57) ABSTRACT

A cross-dipole radiating element includes a first antenna element that includes a first stalk and a first dipole arm and a second antenna element that includes a second stalk and a second dipole arm. The first dipole arm includes an inner dipole segment that extends along a first longitudinal axis and an outer dipole segment that extends along a different second longitudinal axis, and the second dipole arm includes an inner dipole segment that extends along a third longitudinal axis and an outer dipole segment that extends along a different fourth longitudinal axis. A distal end of the inner dipole segment of the first dipole arm merges with a base of the outer dipole segment of the first dipole arm, and a distal end of the inner dipole segment of the second dipole arm merges with a base of the outer dipole segment of the second dipole arm.

### CROSS-REFERENCE TO RELATED APPLICATION

The present application claims priority under 35 U.S.C. § 119 to U.S. Provisional Patent Application Ser. No. 62/893,975, filed Aug. 30, 2019, the entire content of which is incorporated herein by reference.

### BACKGROUND

The present invention generally relates to radio communications and, more particularly, to radiating elements for base station antennas used in cellular communications systems.

Cellular communications systems are well known in the art. In a cellular communications system, a geographic area is divided into a series of regions that are referred to as “cells” which are served by respective base stations. The base station may include one or more base station antennas that are configured to provide two-way radio frequency (“RF”) communications with mobile subscribers that are within the cell served by the base station. In many cases, each base station is divided into “sectors.” In perhaps the most common configuration, a hexagonally shaped-cell is divided into three 120° sectors, and each sector is served by one or more base station antennas that have an azimuth Half Power Beamwidth (HPBW) of approximately 65°. Typically, the base station antennas are mounted on a tower or other raised structure, with the radiation patterns (also referred to herein as “antenna beams”) that are generated by the base station antennas directed outwardly. Base station antennas are often implemented as linear or planar phased arrays of radiating elements.

In order to accommodate the ever-increasing volume of cellular communications, cellular operators have added cellular service in a variety of new frequency bands. Cellular operators have applied a variety of approaches to support service in these new frequency bands, including deploying linear arrays of “wide-band” radiating elements that provide service in multiple frequency bands, and deploying multiband base station antennas that include multiple linear arrays (or planar arrays) of radiating elements that support service in different frequency bands. One very common multiband base station antenna design includes one linear array of “low-band” radiating elements that are used to provide service in some or all of the 694-960 MHz frequency band and two linear arrays of “high-band” radiating elements that are used to provide service in some or all of the 1427-2690 MHz frequency band. These linear arrays are mounted in side-by-side fashion.

### SUMMARY

Pursuant to embodiments of the present invention, cross-dipole radiating elements are provided that include a unitary first antenna element that includes a first forwardly-extending stalk and a first dipole arm extending at a first angle from the first forwardly-extending stalk and a unitary second antenna element that includes a second forwardly-extending stalk and a second dipole arm extending at a second angle from the second forwardly-extending stalk. The first dipole arm includes an inner dipole segment that extends along a first longitudinal axis and an outer dipole segment that extends along a second longitudinal axis that is different from the first longitudinal axis. The second dipole arm includes an inner dipole segment that extends along a third longitudinal axis and an outer dipole segment that extends along a fourth longitudinal axis that is different from the third longitudinal axis. A distal end of the inner dipole segment of the first dipole arm merges with a base of the outer dipole segment of the first dipole arm, and a distal end of the inner dipole segment of the second dipole arm merges with a base of the outer dipole segment of the second dipole arm.

In some embodiments, the first longitudinal axis may be substantially parallel to the second longitudinal axis. In some embodiments, the second longitudinal axis may also be substantially collinear with the fourth longitudinal axis. The inner dipole segments of the first and second dipole arms and the outer dipole segments of the first and second dipole arms may all be coplanar in some embodiments.

In some embodiments, the first dipole arm may further include a transverse extension that is positioned to capacitively couple with the inner dipole segment of the second dipole arm. This transverse extension may extend along an axis that is substantially perpendicular to the first longitudinal axis. In some embodiments, the transverse extension may extend along a fifth longitudinal axis that is substantially perpendicular to the first longitudinal axis, and a length of the transverse extension along the fifth longitudinal axis may be greater than a width of the inner dipole segment of the first dipole arm along the fifth longitudinal axis.

In some embodiments, the cross-dipole radiating element further includes a unitary third antenna element that includes a third forwardly-extending stalk and a third dipole arm extending at a third angle from the third forwardly-extending stalk and a unitary fourth antenna element that includes a fourth forwardly-extending stalk and a fourth dipole arm extending at a fourth angle from the fourth forwardly-extending stalk. The first dipole arm along with the third dipole arm may form a first dipole radiator and the second dipole arm along with the fourth dipole arm may form a second dipole radiator.

In some embodiments, a first length of the inner dipole segment of the first dipole arm along the first longitudinal axis may be less than a second length of the outer dipole segment of the first dipole arm along the second longitudinal axis.

In some embodiments, the first antenna element may further include a mounting base that extends from an end of the first forwardly-extending stalk that is opposite the first dipole arm. This mounting base may be configured to capacitively couple to a ground plane.

In some embodiments, an L-shaped gap having a first gap region and a second gap region that extends substantially perpendicularly to the first gap region may separate the first dipole arm from the second dipole arm. The transverse extension of the first dipole arm and the inner dipole segment of the second dipole arm may define the first gap region. The inner dipole segment of the first dipole arm and the inner dipole segment of the second dipole arm may define the second gap region. A length of the first gap region exceeds a length of the second gap region.

In some embodiments, the cross-dipole radiating element may further include a first feed line that has a first segment that extends adjacent and parallel to the first forwardly-extending stalk, a second segment that extends adjacent and parallel to the third forwardly-extending stalk, and a third segment that connects the first and second segments of the first feed line and a second feed line that has a first segment that extends adjacent and parallel to the second forwardly-extending stalk, a second segment that extends adjacent and parallel to the fourth forwardly-extending stalk, and a third segment that connects the first and second segments of the second feed line.

In some embodiments, the transverse extension of the first dipole arm and the inner dipole segment of the second dipole arm may each include respective rearwardly extending plates that are configured to capacitively couple with each other.

In some embodiments, amounts of capacitive coupling between the first dipole arm and the second and fourth dipole arms and amounts of capacitive coupling between the third dipole arm and the second and fourth dipole arms may be selected so that the first dipole radiator will have a second resonance within an operating frequency band of the first dipole radiator. In some embodiments, the second resonance may be within 30% of the upper edge of the operating frequency band.

In some embodiments, the first and second antenna elements may each be formed of stamped sheet metal.

Pursuant to further embodiments of the present invention, cross-dipole radiating elements are provided that include four unitary antenna elements that each have a forwardly-extending stalk and a dipole arm extending at an angle from the forwardly-extending stalk. The first and third dipole arms form a first dipole radiator and the second and fourth dipole arms form a second dipole radiator. Four L-shaped gaps separates the four dipole arms from each other.

Pursuant to still further embodiments of the present invention, cross-dipole radiating elements are provided that include a first antenna element that includes a first forwardly-extending stalk and a first dipole arm extending at a first angle from the first forwardly-extending stalk and a third antenna element that includes a third forwardly-extending stalk and a third dipole arm extending at a third angle from the third forwardly-extending stalk, where the first and third antenna elements together form a first dipole radiator. These radiating elements further include a first hook balun that has a first segment that extends adjacent and parallel to the first forwardly-extending stalk, a second segment that extends adjacent and parallel to the third forwardly-extending stalk, and a third segment that connects the first and second segments of the first hook balun. The first segment of the first hook balun overlaps the first dipole arm while the second segment of the first hook balun does not overlap the third dipole arm.

### BRIEF DESCRIPTION OF THE DRAWINGS

FIG. 1 is a side perspective view of a base station antenna according to embodiments of the present invention.

FIG. 2 is a front view of the base station antenna of FIG. 1 with the radome removed.

FIG. 3 is a perspective view of one of the cross-dipole radiating elements included in the base station antenna of FIGS. 1-2.

FIG. 4A is a perspective view of one of the antenna elements of the radiating element of FIG. 3.

FIG. 4B is a front view of one of the dipole radiators included in the radiating element of FIG. 3.

FIGS. 5 and 6 are a front view and a side view, respectively, of the radiating element of FIG. 3.

FIG. 7 is a shadow perspective view of the radiating element of FIG. 3 that better illustrates the first and second feed lines of the radiating element.

FIG. 8 is an enlarged perspective view of bottom portions of the stalks of the antenna elements of the radiating element of FIG. 3 that illustrates how they may be capacitively coupled to a reflector.

FIGS. 9A-9G are perspective views illustrating a method of assembling the radiating element of FIG. 3.

FIGS. 10A and 10B are graphs illustrating the return loss and cross-polarization isolation performance of the dipole radiators of the radiating element of FIG. 3.

FIGS. 11A and 11B are graphs illustrating the azimuth patterns of the two dipole radiators of the cross-dipole radiating element of FIG. 3.

FIGS. 12A and 12B are enlarged front and perspective views, respectively, of a portion of a multiband antenna that includes a linear array of the cross-dipole radiating elements of FIG. 3.

FIGS. 13A and 13B are graphs illustrating the return loss and cross-polarization isolation performance of the dipole radiators of the cross-dipole radiating element of FIG. 3 when used in a multiband antenna.

FIGS. 14A and 14B are graphs illustrating the azimuth patterns of the two dipole radiators of the cross-dipole radiating element of FIG. 3 when used in a multiband antenna.

FIG. 15 is a perspective view of a cross-dipole radiating element according to further embodiments of the present invention.

FIG. 16 is a perspective view of a cross-dipole radiating element according to still further embodiments of the present invention.

### DETAILED DESCRIPTION

Pursuant to embodiments of the present invention, cross-dipole radiating elements are provided that may be inexpensive to manufacture and assemble, which may be reasonably small, and which may support a relatively wide operating bandwidth. The radiating elements according to embodiments of the present invention may be formed of stamped sheet metal and may be mounted on a reflector of an antenna by screws, rivets or other conventional fasteners. The radiating elements disclosed herein may be particularly well-suited for use in multiband base station antennas.

The cross-dipole radiating elements according to embodiments of the present invention include a first dipole radiator that directly radiates RF signals at a +45° polarization and a second dipole radiator that directly radiates RF signals at a −45° polarization. Each dipole radiator may comprise a pair of dipole arms that are center fed by respective feed lines. In some embodiments, the radiating elements may comprise four antenna elements, each of which includes a stalk and a dipole arm that may extend, for example, at a right angle from the stalk. The stalk may be used to mount the dipole arm forwardly of a reflector. The radiating element may also include first and second feed lines in the form of, for example, hook baluns, that are used to feed RF signals to and from the respective first and second dipole radiators. The ends of the stalks opposite the dipole arms may include tabs that are used to mount the respective antenna elements to the reflector. In some embodiments, each stalk may be capacitively coupled to the reflector through a respective dielectric gasket.

In some embodiments, each antenna element may be a unitary element that is formed from stamped sheet metal. Each dipole arm may include an inner dipole segment that extends along a first longitudinal axis and an outer dipole segment that extends along a second longitudinal axis that is different from the first longitudinal axis. In other words, the inner and outer dipole segments that form each dipole arm are offset from each other in a transverse direction. In some embodiments, a distal end of the each inner dipole segment merges with a base of its corresponding outer dipole segment.

In some embodiments, the first through fourth dipole arms may be arranged to generally define an “X” when viewed from the front, and a respective L-shaped gap may separate each dipole arm from the two dipoles arms that are adjacent thereto.

In some embodiments, each stalk may attach to a side of the inner dipole segment of its corresponding dipole arm that extends parallel to the longitudinal axis defined by the inner dipole segment.

Embodiments of the present invention will now be discussed in greater detail with reference to the accompanying figures.

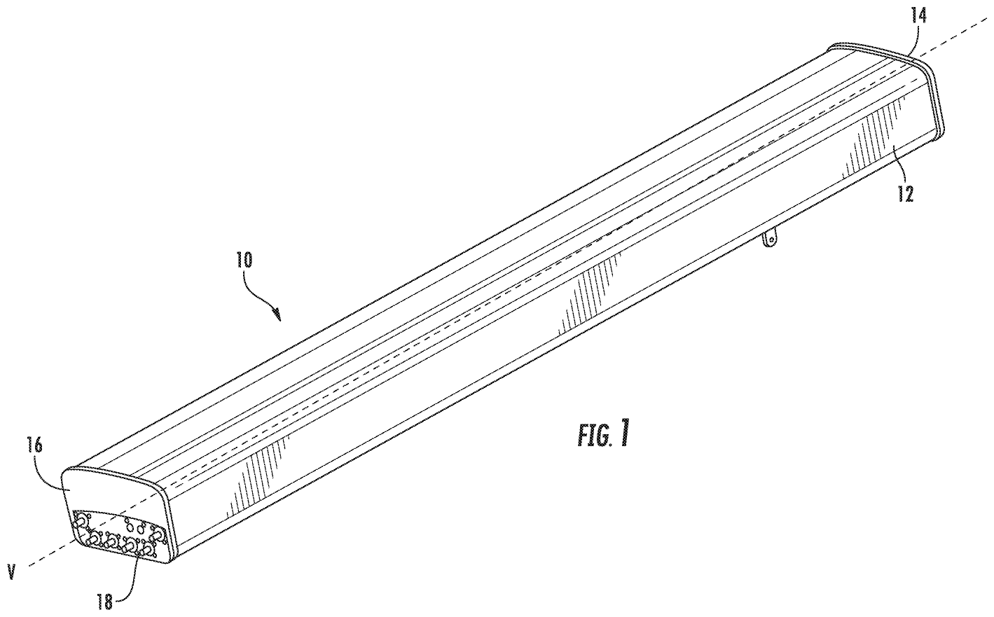

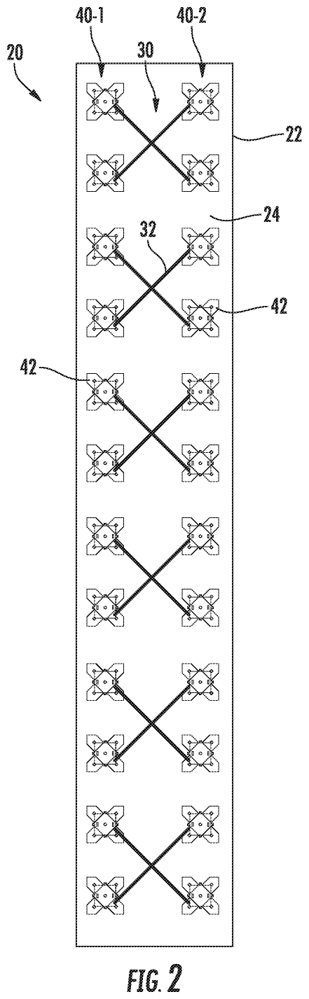

FIGS. 1 and 2 illustrate a base station antenna 10 according to certain embodiments of the present invention. In particular, FIG. 1 is a front perspective view of the base station antenna 10, and FIG. 2 is a front view of the antenna 10 with the radome thereof removed to illustrate the inner components of the antenna.

As shown in FIG. 1, the base station antenna 10 is an elongated structure that extends along a longitudinal axis V. The base station antenna 10 may have a tubular shape with generally rectangular cross-section. The antenna 10 includes a radome 12 and a top end cap 14, which may or may not be integral with the radome 12. The antenna 10 also includes a bottom end cap 16 which includes a plurality of connectors 18 mounted therein. The antenna 10 is typically mounted in a vertical configuration (i.e., the longitudinal axis V may be generally perpendicular to a plane defined by the horizon when the antenna 10 is mounted for normal operation).

As shown in FIG. 2, the base station antenna 10 includes an antenna assembly 20 that may be slidably inserted into the radome 12. The antenna assembly 20 includes a ground plane structure 22 that has a reflector 24. Various mechanical and electronic components of the antenna may be mounted behind the reflector 24 such as, for example, phase shifters, remote electronic tilt (“RET”) units, mechanical linkages, a controller, diplexers, and the like. The reflector 24 may comprise or include a metallic surface that serves as both a reflector and as a ground plane for the radiating elements of the antenna 10.

A plurality of low-band radiating elements 32 and a plurality of high-band radiating elements 42 are mounted to extend forwardly from the reflector 24. The low-band radiating elements 32 are mounted in a vertical column to form a linear array 30 of low-band radiating elements 32, and the high-band radiating elements 42 are mounted in two vertical columns to form two linear arrays 40-1, 40-2 of high-band radiating elements 42. The linear array 30 of low-band radiating elements 32 may be positioned between the two linear arrays 40-1, 40-2 of high-band radiating elements 42. Each linear array 30, 40-1, 40-2 may be used to form a pair of antenna beams, namely a first antenna beam having a +45° polarization and a second antenna beam having a −45° polarization. Note that herein when multiple like elements are provided, the elements may be identified by two-part reference numerals. The full reference numeral (e.g., linear array 40-2) may be used to refer to an individual element, while the first portion of the reference numeral (e.g., the linear arrays 40) may be used to refer to the elements collectively.

The low-band radiating elements 32 may be configured to transmit and receive signals in a first frequency band. In some embodiments, the first frequency band may comprise the 694-960 MHz frequency range or a portion thereof. The high-band radiating elements 42 may be configured to transmit and receive signals in a second frequency band. In some embodiments, the second frequency band may comprise the 1427-2690 MHz frequency range or a portion thereof. It will be appreciated that the number of linear arrays of radiating elements may be varied from what is shown in FIG. 2, as may the number of radiating elements per linear array and/or the positions of the linear arrays.

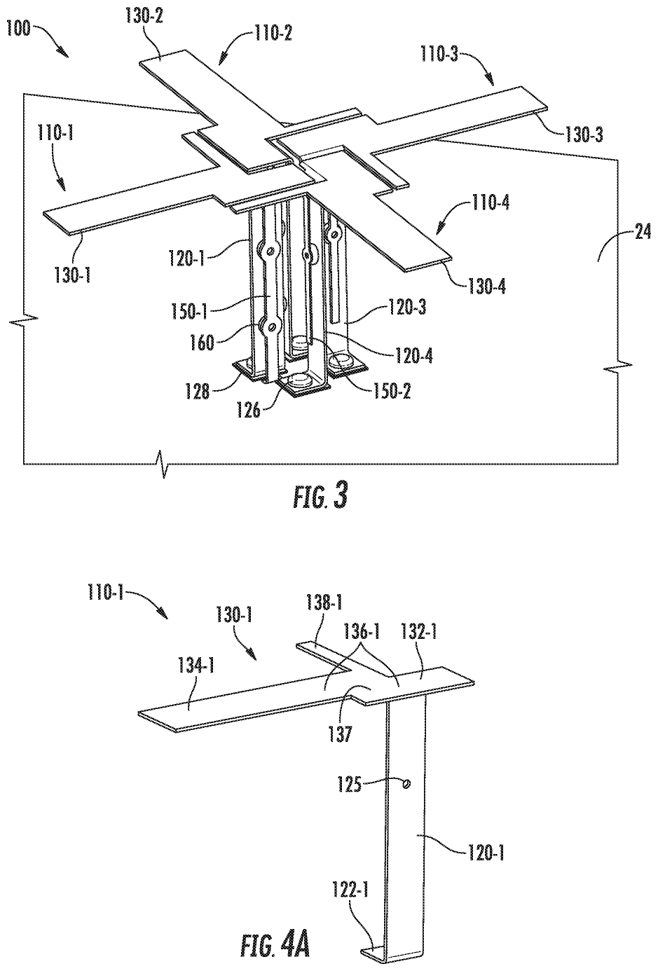

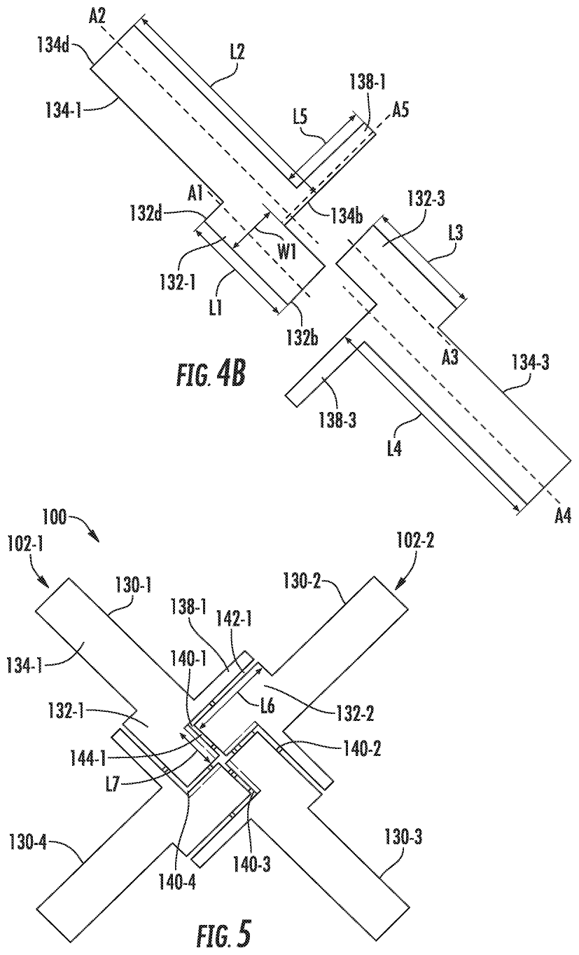

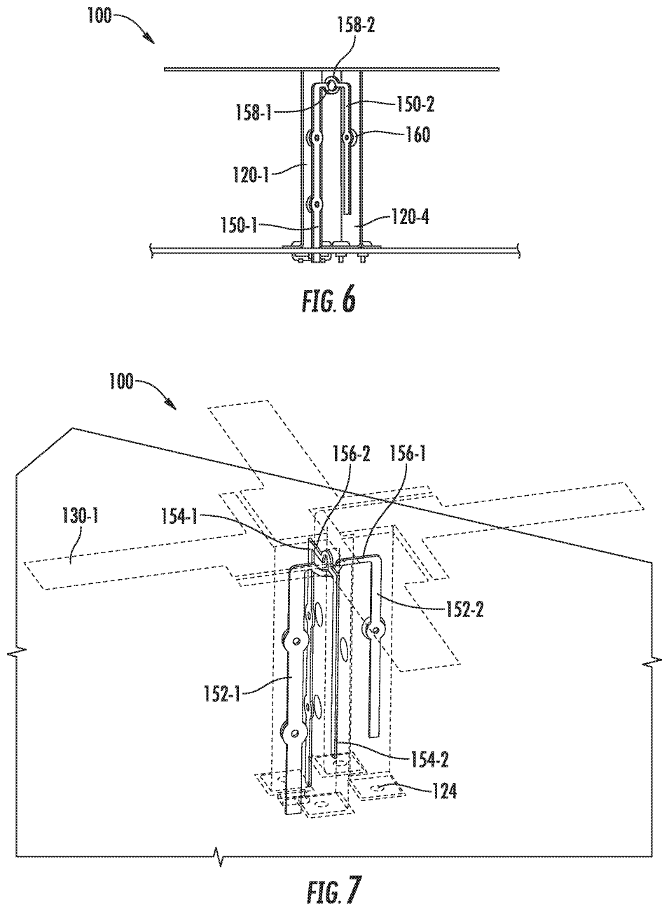

As noted above, embodiments of the present invention provide low cost, high performance radiating elements that may be used, for example, to implement each of the low-band radiating elements 32 shown in FIG. 2. A first embodiment of such a cross-dipole radiating element 100 will now be described with reference to FIGS. 3-8. In particular, FIG. 3 is a perspective view of the cross-dipole radiating element 100. FIG. 4A is a perspective view of one of the four antenna elements included in the radiating element 100 of FIG. 3. FIG. 4B is a front view of one of the dipole radiators included in the radiating element 100. FIGS. 5 and 6 are a front view and a side view, respectively, of the radiating element 100 of FIG. 3. FIG. 7 is a shadow perspective view of the radiating element 100 of FIG. 3 that better illustrates the first and second feed lines thereof. FIG. 8 is an enlarged perspective view of the stalks of the antenna elements that illustrates how they may be capacitively coupled to a reflector.

Referring to FIG. 3, the cross-dipole radiating element 100 includes first through fourth antenna elements 110-1 through 110-4, first and second feed lines 150-1, 150-2, and dielectric spacers 160. Fasteners 126 and dielectric gaskets 128 may be used to mount the radiating element 100 on a reflector 24 of the base station antenna 10.

Referring to FIG. 4A, the first antenna element 110-1 includes a first stalk 120-1 and a first dipole arm 130-1 that extends from the first stalk 120-1 at an angle such, as for example, an angle of about 90 degrees. The end of the first stalk 120-1 that is opposite the first dipole arm 130-1 includes a tab 122-1 that extends from the first stalk 120-1 at an angle of, for example, 90 degrees. The tab 122-1 may include an opening 124-1 (see FIG. 7) that receives a fastener 126 that may be used to mount the first antenna element 110-1 on, for example, a reflector 24 or other structure. Once mounted to the reflector 24, the first stalk 120-1 may extend forwardly from the reflector 24.

Referring to FIGS. 4A and 4B, the first dipole arm 130-1 includes at least an inner dipole segment 132-1 that extends along a first longitudinal axis A1 and an outer dipole segment 134-1 that extends along a second longitudinal axis A2 that is different from (i.e., not collinear with) the first longitudinal axis A1. In the depicted embodiment, the first and second longitudinal axes A1, A2 lie in the same plane (i.e., are coplanar) and extend parallel to one another. Together, the first inner dipole segment 132-1 and the first outer dipole segment 134-1 form a radiating arm 136-1. Since the first and second longitudinal axes A1, A2 are offset from each other, the radiating arm 136-1 includes a jog 137. The inner dipole segment 132-1 includes a base 132b and a distal end 132d. The outer dipole segment 134-1 includes a base 134b and a distal end 134d. The distal end 132d of the inner dipole segment 132-1 merges with the base 134b of the outer dipole segment 134-1. A first length L1 of the first inner dipole segment 132-1 along the first longitudinal axis A1 is less than a second length L2 of the first outer dipole segment 134-1 along the second longitudinal axis A2.

As is further shown in FIGS. 4A-4B, the first dipole arm 130-1 may further include a transverse extension 138-1. The transverse extension 138-1 may extend from a sidewall of the inner dipole segment 132-1. The transverse extension 138-1 extends along a longitudinal axis A5 that is substantially perpendicular to the first longitudinal axis A1. A length L5 of the transverse extension 138-1 along the longitudinal axis A5 thereof is greater than a width W1 of the inner dipole segment 132-1 along the longitudinal axis A5 of the transverse extension 138-1.

The third dipole arm 130-3 includes an inner dipole segment 132-3 that extends along a third longitudinal axis A3 and an outer dipole segment 134-3 that extends along a fourth longitudinal axis A4 that is different from (i.e., not collinear with) the third longitudinal axis A3. The third and fourth longitudinal axes A3, A4 may lie in the same plane and may extend parallel to one another. Together, the inner dipole segment 132-3 and the outer dipole segment 134-3 form a radiating arm 136-3. The second longitudinal axis A2 may be substantially collinear with the fourth longitudinal axis A4 in some embodiments.

Referring again to FIG. 3, the cross-dipole radiating element 100 includes a total of four antenna elements 110-1 through 110-4. In some embodiments, each of the antenna elements 110 may have the exact same design, although embodiments of the present invention are not limited thereto. In an example embodiment, the antenna elements 110 may be formed from sheet metal that is, for example, 0.5-1.2 mm thick (e.g., 0.8 mm thick). The sheet metal may comprise, for example, aluminum or copper.

As will be described in greater detail below, antenna elements 110-1 and 110-3 are each center fed by a first feed line 150-1, while antenna elements 110-2 and 110-4 are each center fed by a second feed line 150-2. Antenna elements 110-1 and 110-3 together form a first dipole radiator 102-1, while antenna elements 110-2 and 110-4 together form a second dipole radiator 102-2.

As shown best in FIG. 5, four L-shaped gaps 140-1 through 140-4 are provided that separate each dipole arm 130 from the two dipole arms 130 adjacent thereto. Each L-shaped gap 140 has a first gap region 142 and a second gap region 144 that extends substantially perpendicularly to the first gap region 142. Focusing, for example, on L-shaped gap 140-1, a sidewall of the transverse extension 138-1 of the first dipole arm 130-1 and a sidewall of the inner dipole segment 132-2 of the second dipole arm 130-2 define the first gap region 142-1. The transverse extension 138-1 of the first dipole arm 130-1 is positioned to capacitively couple with the inner dipole segment 132-2 of the second dipole arm 130-2 across the first gap region 142-1 via edge coupling. A sidewall of the inner dipole segment 132-1 of the first dipole arm 130-1 and the base 132b of the inner dipole segment 132-2 of the second dipole arm 130-2 define the second gap region 144-1. A length L6 of the first gap region 142-1 exceeds a length L7 of the second gap region 144-1 in some embodiments. The inner dipole segment 132-1 of the first dipole arm 130-1 is positioned to capacitively couple with the inner dipole segment 132-2 of the second dipole arm 130-2 across the second gap region 144-1 via edge coupling.

Each of the remaining L-shaped gaps 140-2 through 140-4 may be identical to the first L-shaped gap 140-1 except that they are positioned between different combinations of the dipole arms 130.

Referring to FIGS. 3 and 7-8, each antenna element 110 may be capacitively coupled to the reflector of a base station antenna (e.g., to reflector 24 of base station antenna 10). Dielectric gaskets 128 may be positioned between the tabs 122 of each stalk 120 and the reflector 24. A respective fastener 126 may be inserted through the opening 124 in each tab 122, through an opening in the dielectric gasket 128 and through a corresponding opening (not shown) in the reflector 24 in order to mount each antenna element 110 to extend forwardly from the reflector 24. Since each antenna element 110 is capacitively coupled to the reflector, there is no need to solder the antenna elements 110 to the reflector 24, and the capacitive connections remove possible sources of passive intermodulation distortion. In some embodiments, the only soldering points may be first and second soldered connections between the center conductors of respective feed cables and the respective feed lines 150-1, 150-2.

Referring to FIGS. 3, 4A, 6 and 7, the cross-dipole radiating element 100 further includes first and second feed lines 150-1, 150-2. Each feed line 150 may be coupled to a conductor of a transmission line (e.g., the center conductor of a coaxial cable) that feeds RF signals to and from the cross-dipole radiating element 100. As shown, each feed line 150 may take the form of a hook balun 150 in an example embodiment. Focusing on hook balun 150-1, it can be seen that the hook balun includes a first segment 152-1 that extends adjacent and parallel to the first stalk 120-1, a second segment 154-1 that extends adjacent and parallel to the third stalk 120-3, and a third segment 156-1 that connects the first segment 152-1 to the second segment 154-1. Similarly, the second hook balun 150-2 includes a first segment 152-2 that extends adjacent and parallel to the second stalk 120-2, a second segment 154-2 that extends adjacent and parallel to the fourth stalk 120-4, and a third segment 156-2 that connects the first segment 152-2 to the second segment 154-2. The third segment 156-1 of the first feed line 150-1 has a rearwardly extending semicircular section 158-1 while the third segment 156-2 of the second feed line 150-2 has a forwardly extending semicircular section 158-2. The semicircular sections 158 allow the two hook baluns 150 to cross one another while remaining electrically isolated from each other. The first and second segments 152, 154 of each hook balun 150 may include widened portions that have openings 155.

A plurality of dielectric spacers 160 are provided that are used to mount the hook baluns 150 on the stalks 120-1 through 120-4. The dielectric spacers 160 may comprise, for example, plastic disks having a predetermined thickness and dielectric constant. The plastic disks may include first and second nubs that extend from the opposed major surfaces thereof that are configured to be received in respective openings 125 and 155 in the stalks 120 and the feed lines 150. The dielectric spacers 160 also act to space the feed lines 150-1, 150-2 at a predetermined distance from the stalks 120 on which the feedlines 150 are mounted so that the feed lines 150 and the stalks 120 together form a pair of microstrip transmission lines. The feed lines 150 may transfer RF signals to and from the dipole arms 130 in a manner known to those of skill in the art.

The first dipole arm 130-1 capacitively couples with both the second dipole arm 130-2 and the fourth dipole arm 130-4 across the respective L-shaped gaps 140-1 and 140-4. The respective amounts of capacitive coupling between the first dipole arm 130-1 and the second and fourth dipole arms 130-2, 130-4 are selected so that the first dipole radiator 102-1 will have a second resonance within an operating frequency band of the cross-dipole radiating element 100. In some embodiments, the second resonance is within the upper half of the operating frequency band. In some embodiments, the second resonance is within 30% of the upper edge of the operating frequency band. In other embodiments, the second resonance is within 20% of the upper edge of the operating frequency band. In still other embodiments, the second resonance may be just outside the operating frequency band (e.g., within 15% of the operating frequency band).

Since each dipole arm 130 is capacitively loaded by the dipole arms 130 of the other dipole radiator 102, each dipole arm 130 may have a reduced length that is, for example, about 0.2-0.24 of a wavelength of the center frequency of the operating frequency band (which is 827 MHz for the 694-960 MHz operating frequency band). As was also described above, the L-shaped coupling structure may be configured so that the dipole radiators 102 will each have a second resonance within the operating frequency band.

Referring again to FIG. 3, it can be seen that the first stalk 120-1 connects to a sidewall of the inner dipole segment 132-1 of the first dipole arm 130-1 at a point where the first antenna element 110-1 transitions through a 90 degree bend. The first segment 152-1 of the first feed line 150-1 is positioned directly behind the inner dipole segment 132-1 of the first dipole arm 130-1 when the radiating element 100 is mounted for use since the first feed line 150-1 is mounted on the “inner” side of the stalk 120-1 that connects to the first dipole arm 130-1 at a 90 degree angle (as opposed to the outer side of the stalk 120-1 that connects to the first dipole arm at a 270 degree angle). As such, the first segment 152-1 of the first feed line 150-1 “horizontally overlaps” the inner dipole segment 132-1 of the first dipole arm 130-1 when the radiating element 100 is mounted for use. Herein, a first element such as radiating element or a portion thereof “horizontally overlaps” a second radiating element if an axis that is perpendicular to the reflector on which the radiating elements are mounted passes through both radiating elements. In contrast, the second segment 154-1 of the first feed line 150-1 is not positioned directly behind (and hence does not horizontally overlap) the inner dipole segment 132-3 of the third dipole arm 130-3 when the radiating element 100 is mounted for use since the first feed line 150-1 is mounted on the “outer” side of the stalk 120-3 of the third dipole arm 130-3. Similarly, the first segment 152-2 of the second feed line 150-2 is positioned directly behind (and hence horizontally overlaps) the inner dipole segment 132-2 of the second dipole arm 130-2 when the radiating element 100 is mounted for use since the second feed line 150-2 is mounted on the inner side of the stalk 120-2, while the second segment 154-2 of the second feed line 150-2 is not positioned directly behind (and hence does not horizontally overlap) the inner dipole segment 132-4 of the fourth dipole arm 130-4 when the radiating element 100 is mounted for use.

While not shown in the figures, the radiating element 100 may further include one or more dielectric separators that help maintain the antenna elements 110 in their proper positions and/or that prevent any of the antenna elements 110 from coming into direct physical contact with other of the antenna elements 110. The dielectric separator may include tabs that extend into the L-shaped gap regions 140 in some embodiments.

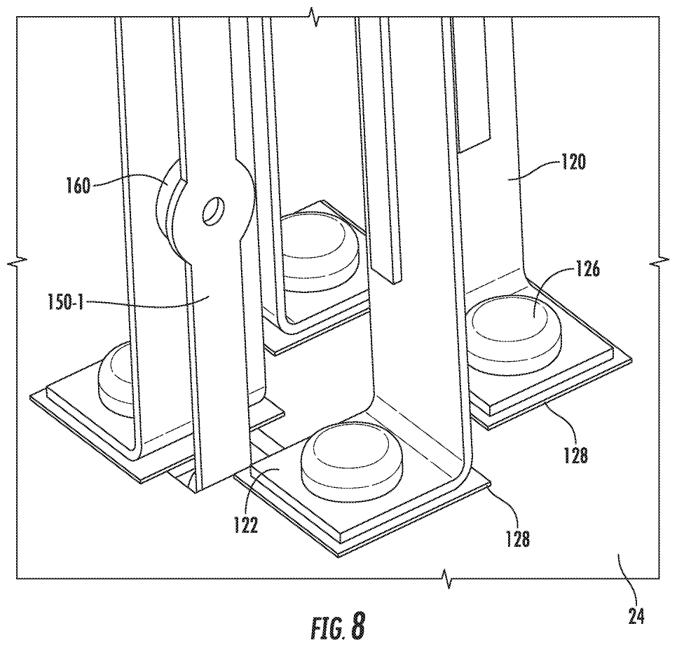

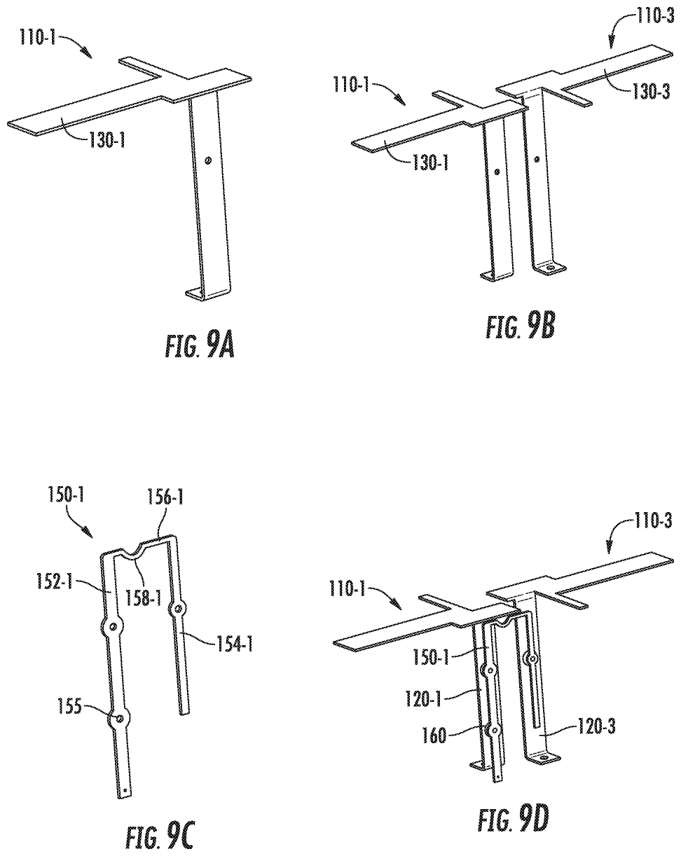

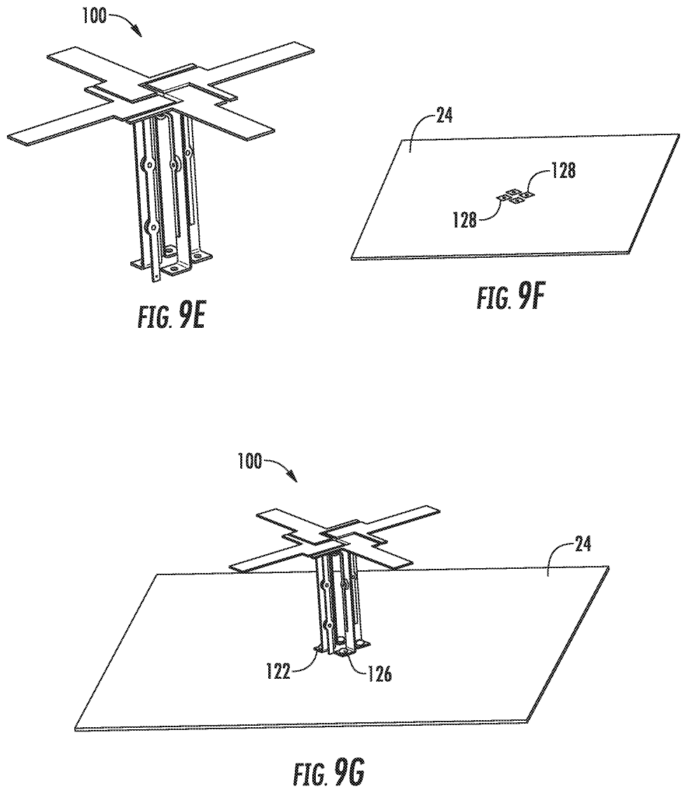

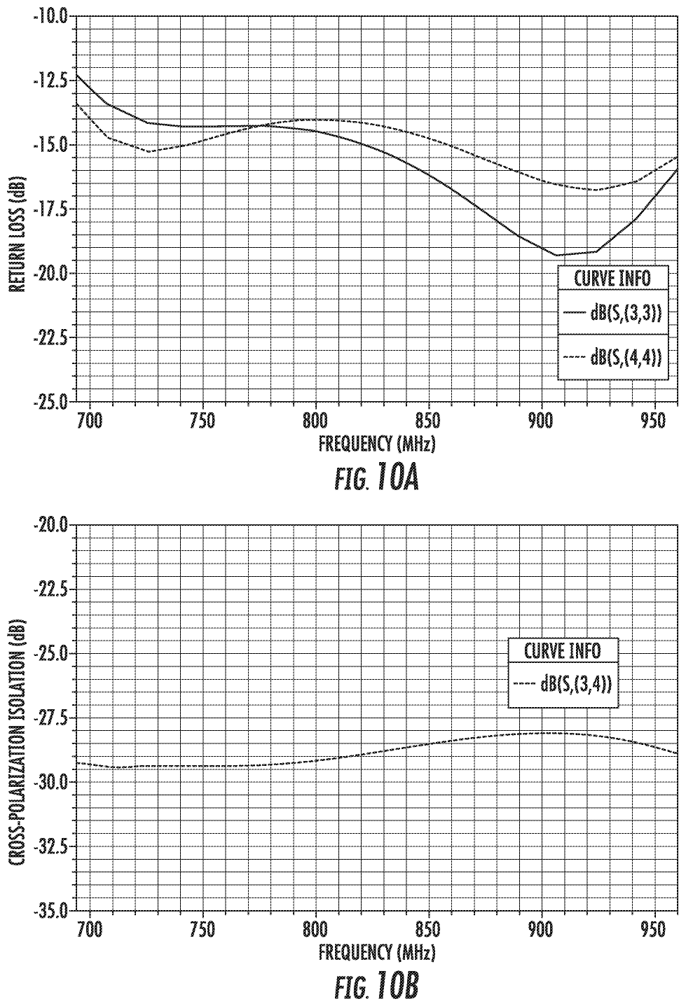

FIGS. 9A-9G are perspective views illustrating a method of assembling the radiating element 100 of FIG. 3. As shown in FIGS. 9A and 9B, the first and third antenna elements 110-1, 110-3 may be arranged so that the dipole arms 130-1, 130-3 thereof face in opposed directions. In some embodiments, the dipole arms 130-1, 130-3 may be aligned along a common longitudinal axis. Referring to FIGS. 9C and 9D, the first feed line 150-1 is mounted on the stalks 120-1, 120-3 of the first and third antenna elements 110-1, 110-3 using a plurality of dielectric spacers 160. Referring to FIG. 9E, antenna elements 110-2, 110-4 are arranged in the same manner as antenna elements 110-1, 110-3, but rotated 90°, and the second feed line 150-2 is attached to antenna elements 110-2, 110-4 in the same fashion that feed line 150-1 is attached to antenna elements 110-1, 110-3. Referring to FIGS. 9F and 9G, dielectric gaskets 128 are interposed between the tabs 122 on the stalks 120, and fasteners 126 are inserted through the tabs 122, gaskets 128 and reflector 24 to mount the antenna elements 110 to extend forwardly from the reflector 24.

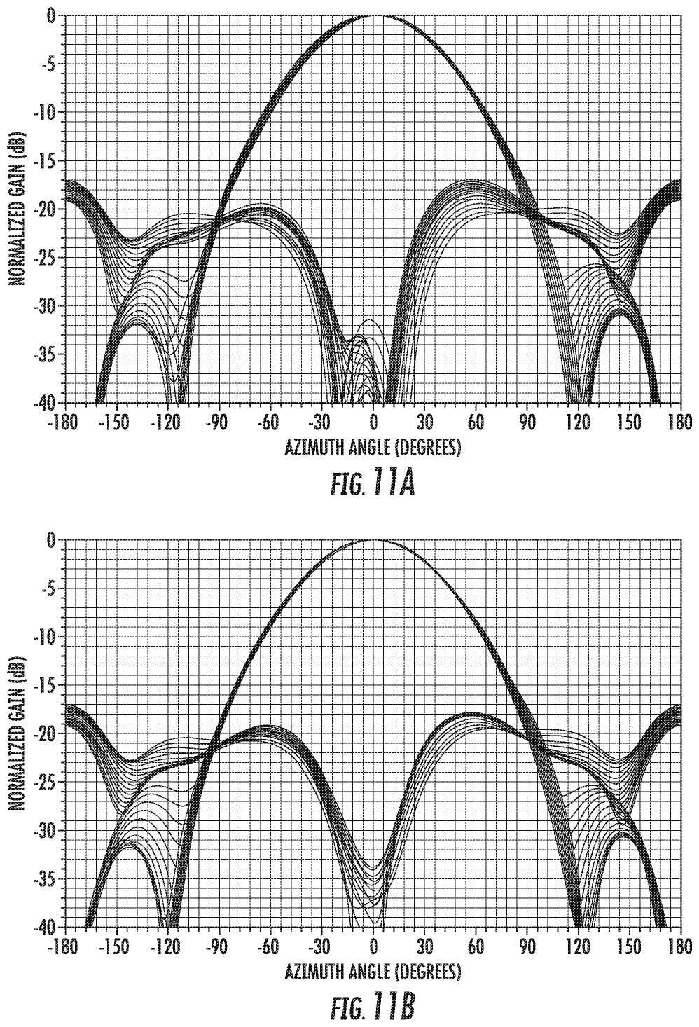

FIGS. 10A and 10B illustrate the simulated performance of the cross-dipole radiating element 100 of FIG. 3 when modeled as being mounted alone on a reflector. As shown in FIG. 10A, both dipole radiators 102 of the cross-dipole radiating element 100 exhibits a return loss of less than 12 dB across the entire 694-960 MHz operating frequency band. As shown in FIG. 10B, the isolation between the cross polarized dipole radiators 102-1, 102-2 is at least 28 dB across the entire operating frequency band.

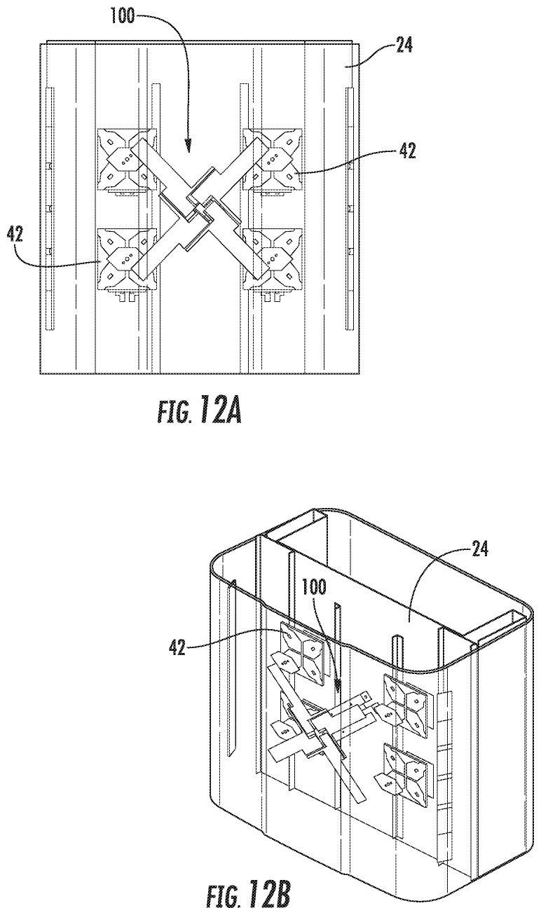

FIGS. 11A and 11B are graphs of the azimuth patterns for the two dipole radiators 102-1, 102-2. The 3 dB azimuth beamwidth is 69 degrees, and the cross polarization ratio at boresight is 34 dB. The cross polarization ratio at the edge of a 120 degree sector is 9.4 dB.

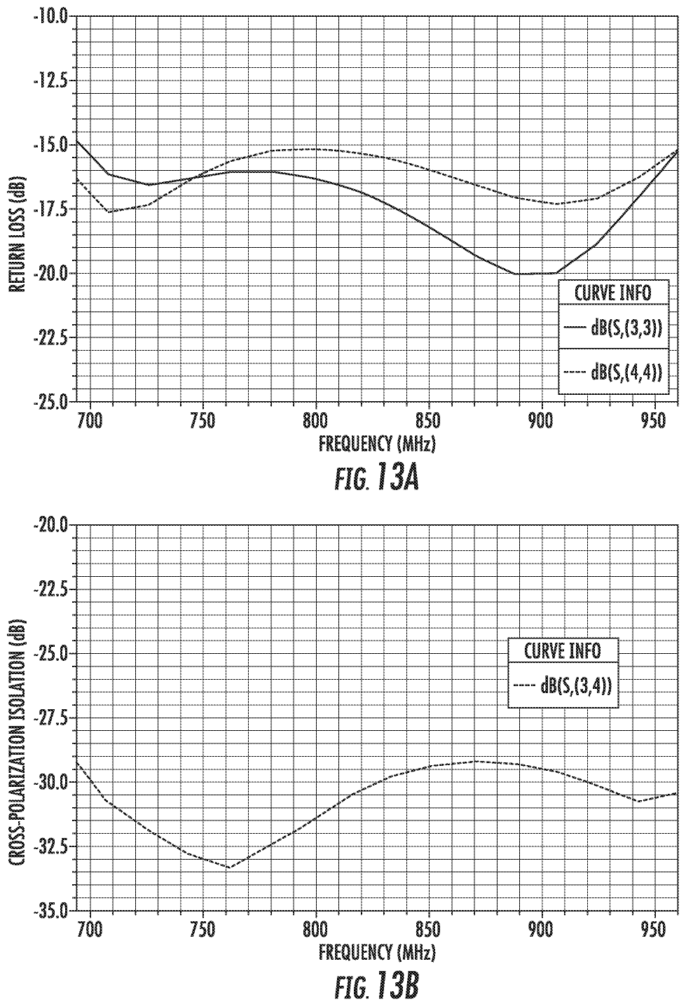

As discussed above, the radiating element 100 may be used to implement the low-band radiating elements 32 of the multiband base station antenna 10. FIG. 12 is an enlarged front view of a portion of such a base station antenna that illustrates the positioning of the low-band radiating element 100 with respect to the closest four high-band radiating elements 42. As shown in FIG. 12, each outer dipole segment 134 of cross-dipole radiating element 100 may horizontally overlap a respective one of the high-band radiating elements 42.

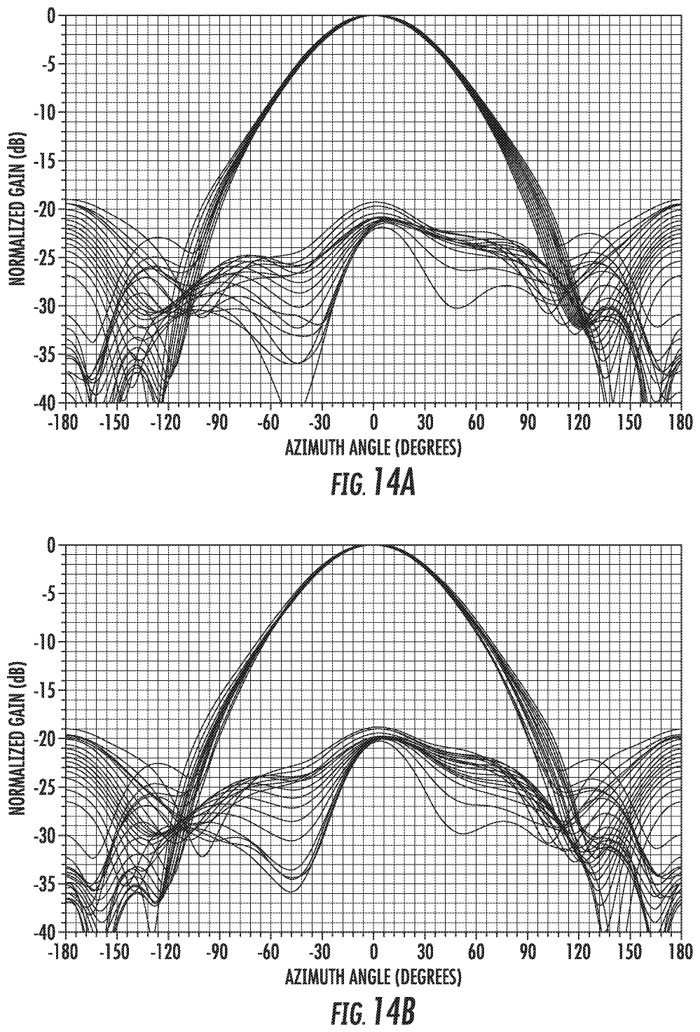

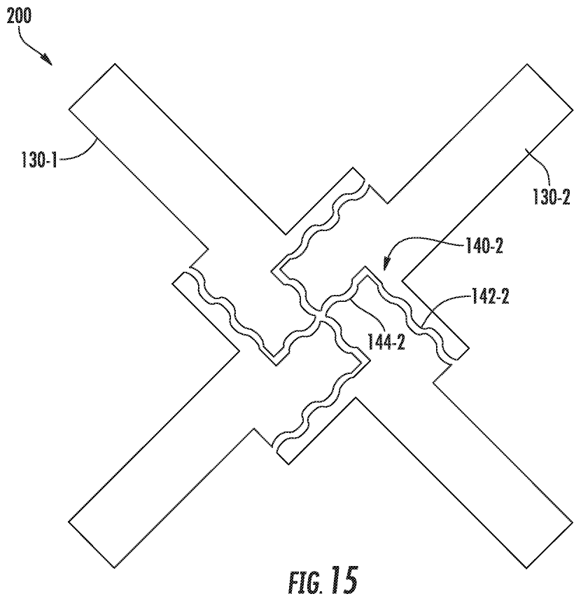

The performance of the low-band radiating element 100 may be impacted by the presence of nearby high-band radiating elements. FIGS. 13A-14B illustrate the measured performance of the cross-dipole radiating element 100 when used in a multiband antenna.

In particular, FIGS. 13A and 13B illustrate measured return loss and cross polarization isolation performance of the cross-dipole radiating element 100 of FIG. 3 when used in the multiband antenna of FIG. 12. As shown in FIG. 13A, the cross-dipole radiating element 100 exhibits a return loss of less than 14.8 dB across the entire 694-960 MHz operating frequency band. As shown in FIG. 13B, the isolation between the cross polarized dipole radiators 102-1, 102-2 is at least 29 dB across the entire operating frequency band.

FIGS. 14A and 14B are graphs of the azimuth patterns for the two dipole radiators 102-1, 102-2 when the radiating element is implemented in the multiband antenna of FIG. 12. The 3 dB azimuth beamwidth is 67 degrees, and the cross polarization ratio at boresight is 21 dB. The cross polarization ratio at the edge of a 120 degree sector is 13.5 dB.

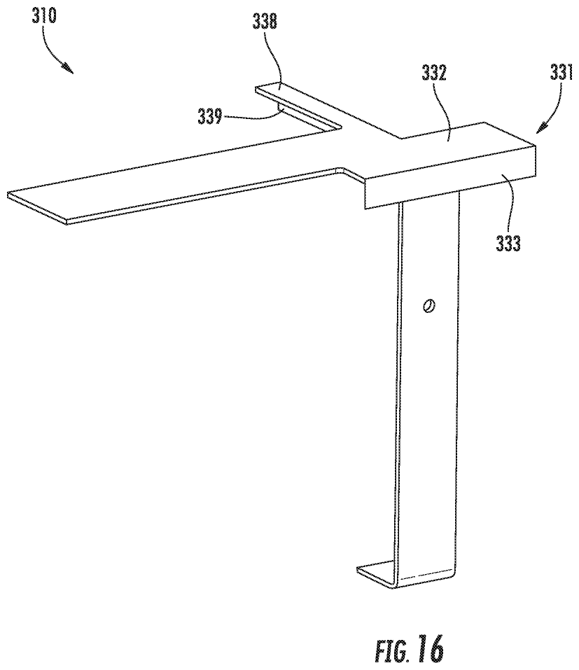

FIG. 15 is a perspective view of a cross-dipole radiating element 200 according to further embodiments of the present invention. The cross-dipole radiating element 200 may be very similar to the cross-dipole radiating element 100, with the primary difference being that the first and second gap regions 142, 144 of each L-shaped gap have undulating profiles as opposed to straight profiles. The embodiment of FIG. 15 illustrates that the L-shaped gaps need not have perfect rectilinear “L” shapes.

FIG. 16 is a perspective view of an antenna element 310 according to still further embodiments of the present invention. The antenna element 310 may be used to replace each of the antenna elements 110 in the cross-dipole radiating element 100 of FIG. 3. The antenna element 310 is very similar to the antenna element 110, with the primary difference being that the antenna element 310 is designed to capacitively couple with two neighboring antenna elements 310 (not shown) other through a combination of both edge coupling and plate coupling. In particular, the base 132b of the inner dipole segment 332 includes a rearwardly extending tab 331 (not visible in FIG. 16 but its location is shown by an arrow) that is arranged to form a plate capacitor with the stalk 120 of an adjacent antenna element 310 (not shown). Additionally, each transverse extension 338 includes a rearwardly extending tab 339 and the sidewall of the inner dipole segment 332 of a neighboring antenna element 310 (not shown) that is opposite the transverse extension 338 likewise includes a rearwardly extending tab 333. Respective pairs of the tabs 339 and 333 are arranged to form additional plate capacitors. The use of plate coupling may allow for the use of smaller transverse extensions 338 and/or for larger gaps between adjacent antenna elements 310.

The cross-dipole radiating elements according to embodiments of the present invention may be inexpensive to manufacture as the four antenna elements and the two feed lines may be formed by simply stamping and bending sheet metal. The antenna element may also be simple to assemble, as shown above with reference to FIGS. 9A-9G.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A cross-dipole radiating element, comprising:
a unitary first antenna element that includes a first forwardly-extending stalk and a first dipole arm extending at a first angle from the first forwardly-extending stalk;
a unitary second antenna element that includes a second forwardly-extending stalk and a second dipole arm extending at a second angle from the second forwardly-extending stalk;
wherein the first dipole arm includes an inner dipole segment that extends along a first longitudinal axis and an outer dipole segment that extends along a second longitudinal axis that is different from the first longitudinal axis,
wherein the second dipole arm includes an inner dipole segment that extends along a third longitudinal axis and an outer dipole segment that extends along a fourth longitudinal axis that is different from the third longitudinal axis, and
wherein a distal end of the inner dipole segment of the first dipole arm merges with a base of the outer dipole segment of the first dipole arm, and a distal end of the inner dipole segment of the second dipole arm merges with a base of the outer dipole segment of the second dipole arm.

2. The cross-dipole radiating element of claim 1, wherein the first longitudinal axis is substantially parallel to the second longitudinal axis.

3. (canceled)

4. The cross-dipole radiating element of claim 1, wherein the inner dipole segments of the first and second dipole arms and the outer dipole segments of the first and second dipole arms are all coplanar.

5. The cross-dipole radiating element of claim 1, the first dipole arm further comprising a transverse extension that is positioned to capacitively couple with the inner dipole segment of the second dipole arm.

6. The cross-dipole radiating element of claim 5, wherein the transverse extension of the first dipole arm extends along an axis that is substantially perpendicular to the first longitudinal axis.

7. (canceled)

8. The cross-dipole radiating element of claim 1, wherein a first length of the inner dipole segment of the first dipole arm along the first longitudinal axis is less than a second length of the outer dipole segment of the first dipole arm along the second longitudinal axis.

9-10. (canceled)

11. The cross-dipole radiating element of claim 1, wherein an L-shaped gap having a first gap region and a second gap region that extends substantially perpendicularly to the first gap region separates the first dipole arm from the second dipole arm.

12-15. (canceled)

16. The cross-dipole radiating element of claim 5, wherein the transverse extension of the first dipole arm and the inner dipole segment of the second dipole arm each include respective rearwardly extending plates that are configured to capacitively couple with each other.

17-19. (canceled)

20. A cross-dipole radiating element, comprising:
a unitary first antenna element that includes a first forwardly-extending stalk and a first dipole arm extending at a first angle from the first forwardly-extending stalk;
a unitary second antenna element that includes a second forwardly-extending stalk and a second dipole arm extending at a second angle from the second forwardly-extending stalk;
a unitary third antenna element that includes a third forwardly-extending stalk and a third dipole arm extending at a third angle from the third forwardly-extending stalk; and
a unitary fourth antenna element that includes a fourth forwardly-extending stalk and a fourth dipole arm extending at a fourth angle from the fourth forwardly-extending stalk,
wherein the first dipole arm along with the third dipole arm form a first dipole radiator and the second dipole arm along with the fourth dipole arm form a second dipole radiator,
wherein a first L-shaped gap separates the first dipole arm from the second dipole arm,
wherein a second L-shaped gap separates the second dipole arm from the third dipole arm,
wherein a third L-shaped gap separates the third dipole arm from the fourth dipole arm, and
wherein a fourth L-shaped gap separates the fourth dipole arm from the first dipole arm.

21. The cross-dipole radiating element of claim 20, wherein the first dipole arm includes an inner dipole segment that extends along a first longitudinal axis and an outer dipole segment that extends along a second longitudinal axis that is different from the first longitudinal axis, and wherein the second dipole arm includes an inner dipole segment that extends along a third longitudinal axis and an outer dipole segment that extends along a fourth longitudinal axis that is different from the third longitudinal axis.

22. (canceled)

23. The cross-dipole radiating element of claim 21, wherein the first dipole arm further comprises a transverse extension that is positioned to capacitively couple with the inner dipole segment of the second dipole arm.

24. The cross-dipole radiating element of claim 23, wherein the first L-shaped gap has a first gap region and a second gap region that extends substantially perpendicularly to the first gap region, and wherein the transverse extension of the first dipole arm and the inner dipole segment of the second dipole arm define the first gap region.

25-26. (canceled)

27. The cross-dipole radiating element of claim 20, further comprising:
a first feed line that has a first segment that extends adjacent and parallel to the first forwardly-extending stalk, a second segment that extends adjacent and parallel to the third forwardly-extending stalk, and a third segment that connects the first and second segments of the first feed line; and
a second feed line that has a first segment that extends adjacent and parallel to the second forwardly-extending stalk, a second segment that extends adjacent and parallel to the fourth forwardly-extending stalk, and a third segment that connects the first and second segments of the second feed line.

28. The cross-dipole radiating element of claim 27, wherein the first segment of the first feed line is directly behind the first dipole arm while the second segment of the first feed line is not directly behind the third dipole arm.

29. A cross-dipole radiating element that is configured for mounting to extend forwardly from a reflector, comprising:
a first antenna element that includes a first forwardly-extending stalk and a first dipole arm extending at a first angle from the first forwardly-extending stalk;
a third antenna element that includes a third forwardly-extending stalk and a third dipole arm extending at a third angle from the third forwardly-extending stalk, wherein the first and third antenna elements together form a first dipole radiator; and
a first hook balun that has a first segment that extends adjacent and parallel to the first forwardly-extending stalk, a second segment that extends adjacent and parallel to the third forwardly-extending stalk, and a third segment that connects the first and second segments of the first hook balun,
wherein the first segment of the first hook balun overlaps the first dipole arm while the second segment of the first hook balun does not overlap the third dipole arm.

30. The cross-dipole radiating element of claim 29, further comprising:
a second antenna element that includes a second forwardly-extending stalk and a second dipole arm extending at a second angle from the second forwardly-extending stalk;
a fourth antenna element that includes a fourth forwardly-extending stalk and a fourth dipole arm extending at a fourth angle from the fourth forwardly-extending stalk, wherein the second and fourth antenna elements together form a second dipole radiator; and
a second hook balun that has a first segment that extends adjacent and parallel to the second forwardly-extending stalk, a second segment that extends adjacent and parallel to the fourth forwardly-extending stalk, and a third segment that connects the first and second segments of the second hook balun,
wherein the first segment of the second hook balun overlaps the second dipole arm while the second segment of the second hook balun does not overlap the second dipole arm.

31. (canceled)

32. The cross-dipole radiating element of claim 29, wherein the first dipole arm includes an inner dipole segment that extends along a first longitudinal axis and an outer dipole segment that extends along a second longitudinal axis that is different from the first longitudinal axis, and the second dipole arm includes an inner dipole segment that extends along a third longitudinal axis and an outer dipole segment that extends along a fourth longitudinal axis that is different from the third longitudinal axis, and
wherein a distal end of the inner dipole segment of the first dipole arm merges with a base of the outer dipole segment of the first dipole arm, and a distal end of the inner dipole segment of the second dipole arm merges with a base of the outer dipole segment of the second dipole arm.

33. The cross-dipole radiating element of claim 32, wherein the first longitudinal axis is substantially parallel to the second longitudinal axis, and the second longitudinal axis is substantially collinear with the fourth longitudinal axis.

34. The cross-dipole radiating element of claim 32, the first dipole arm further comprising a transverse extension that is positioned to capacitively couple with the inner dipole segment of the second dipole arm.

35. The cross-dipole radiating element of claim 34, wherein an L-shaped gap having a first gap region and a second gap region that extends substantially perpendicularly to the first gap region separates the first dipole arm from the second dipole arm.

36-47. (canceled)
